(19) United States
(12) Patent Application Publication
(10) Pub. No.: US 2010/0029277 A1
(43) Pub. Date: Feb. 4, 2010

(54) Method and Arrangement in a Radio Access Network

(75) Inventors: Hannes Ekström, Stockholm (SE); Mathias Cramby, Sollentuna (SE); Walter Müller, Upplands Vasby (SE); Göran Rune, Linkoping (SE)

Correspondence Address: POTOMAC PATENT GROUP PLLC, P. O. BOX 270, FREDERICKSBURG, VA, 22404, US

(73) Assignee: TELEFONAKTIEBOLAGET L M ERICSSON (PUBL), Stockholm (SE)

(21) Appl. No.: 12/443,542

(22) PCT Filed: Oct. 3, 2007
(86) PCT No.: PCT/SE07/00880

§ 371 Date: Mar. 30, 2009

(30) Foreign Application Priority Data
Oct. 3, 2006 (SE) 0602080-4

(51) Int. Cl. H04W 36/00

(52) U.S. Cl. 455/436

(57) ABSTRACT

The present invention provides a method in a base station for transmitting cell information. The base station is comprised in a radio access network. The base station is adapted to communicate over a radio link with a user equipment located in a cell in the radio access network. The cell is served by the base station and is surrounded by neighbour cells. The method comprises the step of sending a message to the user equipment, using a point-to-point connection over the radio link. The message comprises neighbour cell information to assist the user equipment in handling mobility in idle mode

### TECHNICAL FIELD

The present invention relates generally to a method and an arrangement in a base station in a radio access network and a method and an arrangement in a user equipment in the radio access network. In particular it relates to for transmitting cell information.

### BACKGROUND

In cellular networks the network typically broadcasts information which the user equipment such as e.g. a mobile station uses. A user equipment is a wireless terminal enabling the user to access network services over a radio interface, This information is broadcasted from base stations in the cellular network and is listened to by user equipments in the vicinity of the base stations. The information may e.g. be to know if the user equipment is allowed to access a cell or to find out which neighbour cells it should measure on to get to know the neighbour cells current transmission conditions. The broadcasted information is repeated in certain patterns which are sent continuously on the broadcast channel.

There are two basic ways to handle mobility of a user equipment, either through handover or through cell reselection. Handover is the process in which a user equipment is handed from one cell to the next in order to maintain a radio connection with the network. For handover the network typically controls how the user equipment should behave, e.g. which neighbour cells should be measured on and when to perform the handover, through dedicated signalling to the user equipment, i.e. by using an allocated dedicated physical channel. Cell reselection is performed by user equipments that camp on a cell. A user equipment camping on a cell has completed the cell selection/reselection process and has chosen a cell, the user equipment monitors system information, paging information and neighbouring cells. In this case the user equipment shall regularly search for a better cell according to the cell reselection criteria. If a better cell is found, that cell is selected In the case of cell reselection the user equipment typically controls the mobility itself. The network provides support for cell reselection in the form of broadcasting neighbour cell lists which indicates the cells the user equipment should measure on. The broadcast neighbour cell information is a significant of the total information broadcast, i.e. in WCDMA it typically corresponds to a considerable part of the total amount of data. The part of the total amount of data depends on the configuration of the broadcast information.

### SUMMARY

It is therefore an object of the present invention to provide a mechanism for decreasing the network load.

According to a first aspect of the present invention, the object is achieved by a method in a base station for transmitting cell information. The base station is comprised in a radio access network. The base station is adapted to communicate over a radio link with a user equipment located in a cell in the radio access network. The cell is served by the base station and is surrounded by neighbour cells. The method comprises the step of sending a message to the user equipment, using a point-to-point connection over the radio link. The message comprises neighbour cell information to assist the user equipment in handling mobility in idle mode.

According to a second aspect of the present invention, the object is achieved by a method in a user equipment to obtain cell information. The user equipment is comprised in a radio access network. The user equipment is located in a cell in the radio access network. The cell is served by a base station, is surrounded by neighbour cells and is adapted to communicate with the base station over a radio link. The method comprises the steps of receiving a message from the base station, which message is received on a point-to-point connection over the radio link. The message comprises neighbour cell information to assist the user equipment in handling mobility in idle mode.

According to a third aspect of the present invention, the object is achieved by an arrangement in a base station. The base station is comprised in a radio access network. The base station is adapted to communicate over a radio link with a user equipment located in a cell in the radio access network. The cell is served by the base station and is surrounded by neighbour cells. The base station arrangement (500) comprises a sending unit adapted to send a message to the user equipment, using a point-to-point connection over the radio link. The message comprises neighbour cell information to assist the user equipment in handling mobility in idle mode.

According to a fourth aspect of the present invention, the object is achieved by an arrangement in a user equipment. The user equipment is comprised in a radio access network. The user equipment is located in a cell in the radio access network. The cell is served by a base station and is surrounded by neighbour cells and is adapted to communicate with the base station over a radio link. The user equipment arrangement comprises a receiving unit adapted to receive a message from the base station, which message is received on a point-to-point connection over the radio link. The message comprises neighbour cell information to assist the user equipment in handling mobility in idle mode.

It is an advantage of the present invention that the amount of data that needs to be broadcasted is significantly reduced.

### BRIEF DESCRIPTION OF THE DRAWINGS

FIG. 1 is a schematic block diagram illustrating embodiments of a network.

FIG. 2 is a signalling diagram illustrating an embodiment of a method

FIG. 3 is a combined signalling diagram and flowchart illustrating an embodiment of method

FIG. 4 is a flow chart illustrating embodiments of the method.

FIG. 5 is a schematic block diagram illustrating an embodiment of a device.

FIG. 6 is a flow chart illustrating embodiments of the method.

FIG. 7 is a schematic block diagram illustrating an embodiment of a device.

### DETAILED DESCRIPTION

The invention is defined as a method and an arrangement which may be put into practice in the embodiments described below.

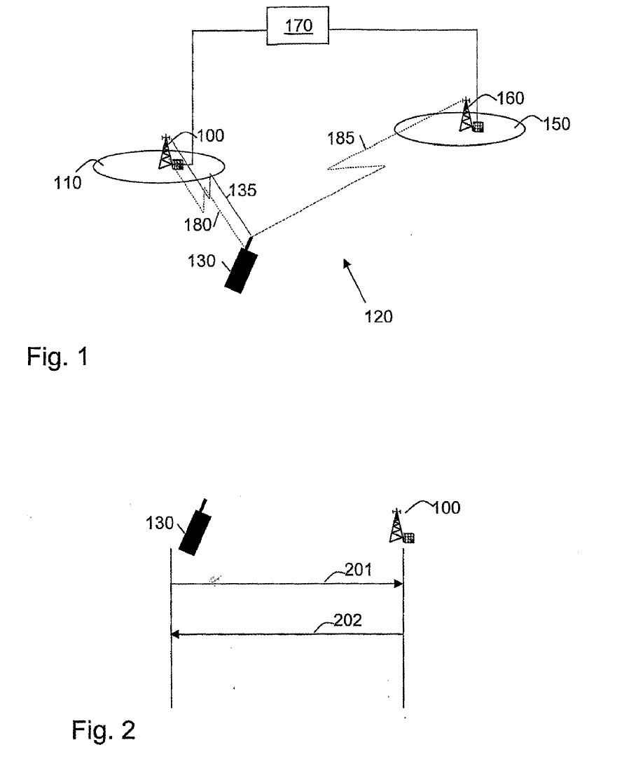

FIG. 1 depicts a base station 100 serving a cell 110 comprised in a radio access network 120 such as e.g. Long Term Evolution (LTE), E-UTRA and Worldwide Interoperability for Microwave Access (Wi MAX), UTRA, WLAN WCD MA GSM/GPRS. The radio access network 120 may be divided into subgroups, each subgroup comprising a number of cells. For example in LTE, the cells in a network are grouped into tracking areas. In UTRAN, cells are grouped into Routing Areas (RA) for the PS domain and Location Areas (LA) for the CS domain, and in GERAN, cells are grouped into Location Areas (LA) for CS domain and in RA for PS domain. A user equipment 130 is located in the cell 110 which makes it possible for the user equipment 130 to communicate with the base station 100 over a radio link 135. T

The user equipment 130 may be any suitable radio communication device such as a laptop, a computer, a mobile phone, a Personal Digital Computer (PDA), or any other radio communication device that can communicate with base stations using radio communication.

The user equipment 130 is further surrounded by a number of neighbour cells comprised in the radio access network, whereof one neighbour cell 150, served by a neighbour base station 160 is depicted in FIG. 1. The base station 100 and the neighbour base station 160 may be any suitable radio base station such as e.g. an eNode-B in E-UTRAN, a Node-B in UTRAN, a base station in WiMAX, which can communicate with user equipments using radio communication.

The radio access network is controlled by one or more nodes, in the example of FIG. 1 the radio access network 120 is controlled by the control node 170 such as e.g. in Idle Mode, Mobile Switching Center (MSC), CS domain and serving GPRS Support Node (SGSN), PS domain controls mobility of respective domain. (GPRS means General Packet Radio Service.) In Active Mode in Universal Terrestrial Radio Access Network (UTRAN), the Radio Network Controllers (RNC) controls the mobility of the user equipment. In Active Mode in GSM EDGE Radio Access Network (GERAN), the Base Station Controller (BSC) controls the mobility of the circuit switched (CS) domain and the SGSN controls the mobility of the packet switched (PS) domain. (EDGE means Enhanced Data rates for Global Evolution.)

The base stations in the radio access network 120 including the base station 100 and the neighbour base station 160 broadcasts signals 180, 185, which may be listened to by surrounding user equipments including the user equipment 130. This user equipment 130 may e.g. listen to the broadcasted signals to continuously be updated on current radio signal status from different cells, to know when a neighbour cell offers better radio signalling and therefore will start a handover or cell reselection process to that cell.

The radio access network 120 has been configured to broadcast neighbour cell information that is required by the user equipment 130 when carrying out mobility procedures such as making neighbour cell search, cell ranking and/or cell selection. A neighbour cell in this document is a cell that is considered to be a candidate for mobility from the originating cell, in which originating cell the neighbour cell list is defined. The neighbour cell list for the different cells can be compiled as a part of network planning, or could possibly be automatically compiled. This information may e.g. be a list of neighbour cells, i.e. cell 150 in FIG. 1, accessible cells known by e.g. the base station 100 which may be based on used service known by e.g. control node 170, subscription known by e.g. control node 170 and user equipment capabilities known by e.g. the base station 100 and control node 170. The information may further be e.g. the services being supported in neighbour cells and how loaded the neighbour cells are and what type of cells the neighbour cells are, such as e.g. macro, micro or home cell.

The neighbour cell information is to be transferred to the user equipments in the network 130, so that e.g. the user equipments know which cells to listen to 130 when handling mobility such as e.g. making neighbour cell search, cell ranking and/or cell selection etc.

According to the present method, the neighbour cell information will not be broadcasted by the base stations in each cell in the network. Instead the neighbour cell information will be sent to each user equipment using dedicated signalling, i.e. using a point-to-point connection over the radio link. This will reduce the amount of data that is required to be broadcasted significantly.

FIG. 2 is a signalling scheme depicting some of the most general embodiments. The method comprises the steps of:

201. The user equipment 130 being in idle mode sends a message from to the base station 100. The message comprising a request for neighbour cell information to assist the user equipment 130 in handling mobility. In some embodiments the neighbour cell information is related to a revision number. If the user equipment 130 earlier has downloaded neighbour cell information related to a revision number, the message comprises this revision number instead of the request.
202. Upon receiving the message sent in step 201, the base station 100 sends a message to the user equipment 130 being in idle mode, using a point-to-point connection. This message comprises neighbour cell information to assist the user equipment 130 in handling mobility. In the embodiments wherein the message comprised the revision number related to neighbour cell information the user equipment 130 already has downloaded, the base station checks if the received revision number is the latest updated. If is not, the base station 100 sends the latest version of neighbour cell information to the user equipment 130. If the received revision number is the latest version of neighbour cell information, the base station 100 does not send any latest version of neighbour cell information to the user equipment 130.

The neighbour cell information to be transferred to the user equipments may comprise information about the closest neighbour cell or cells of the user equipment or information about neighbour cells in a larger area. The term “close” is here used as close in radio conditions and not in distance, i.e. the closest neighbour cell is the cell the user equipment has best radio conditions to, which do not has to be the neighbour cell closest in distance. It may preferably comprise information of multiple neighbour cells, since this reduces the number of times that the procedure of sending neighbour cell information requires to be invoked and since it increases the probability that the user equipment 130 will find a good candidate to move to when it needs to perform a handover or cell reselection. The “best” neighbour cell will depend on network load, user equipment 130 position and lots of other parameters, so giving the user equipment 130 lots of choices will increase the probability that it finds a good candidate. The radio access network 120 may be divided into subgroups, each subgroup comprising a number of cells. In some embodiments the neighbour cell information comprises information about the neighbour cell or cells in one or more subgroups.

The neighbour cell information may be sent to the user equipment 130 at different occasions.

In some embodiments the neighbour cell information is sent when the user equipment 130 registers to a new subgroup within the radio access network 120, e.g. when the power of the user equipment 130 is turned on and it registers with the network. This may be performed such that when the base station 100, serving a cell within the new subgroup, receives the registering of a new subgroup from the user equipment, this triggers the base station 100 to send the neighbour cell information. This may be controlled by the control node 170. In an LTE embodiment, the neighbour cell information may be integrated into a message that is part of the Attach procedure, which message is to be sent from the base station 100 to the user equipment 130. In this case the neighbour cell information may e.g. cover information about one tracking area, multiple tracking areas or one tracking area and the cells immediately neighbouring with the tracking area.

In some embodiments the neighbour cell information is sent when the user equipment 130 moves into a new subgroup within the radio access network 120, e.g. as a result of a handover or a cell reselection. This may be performed such that when the base station 100, serving a cell within the subgroup to which the user equipment 130 has moved, has noted that the user equipment 130 has moved into the cell 110 served by the base station 100 and that the user equipment moves from another subgroup not comprising the cell 110, this triggers the base station 100 to send the neighbour cell information. This may also be controlled by the control node 170. In an LTE embodiment, when the user equipment 130 moves into a new tracking area as a result of a cell reselection, it invokes a tracking area update procedure. In this case the neighbour cell information may be integrated in a tracking area update message to be sent from the base station 100 to the user equipment 130. Also in this case the neighbour cell information may e.g. cover information about one tracking area, multiple tracking areas or one tracking area and the cells immediately neighbouring with the tracking area.

In an LTE embodiment, when the user equipment 130 moves into a target cell served by base station 100, in a new tracking area as a result of handover it invokes a handover procedure. (The base station 100 being the target base station.) In this case the neighbour cell information may be integrated in a Handover command message sent from the base station 100 in the target cell via the network 120 to originating cell for further distribution to the user equipment 130 or as a dedicated message from target cell to the user equipment 130 after handover have been completed. Also in this case the neighbour cell information may e.g. cover information about a subgroup such as one tracking area, multiple tracking areas or one tracking area and the cells immediately neighbouring with the tracking area.

In some embodiments the neighbour cell information is sent when the user equipment 130 realizes that it does not have the neighbour cell list of the subgroup into which it has moved, and therefore requests it as a part of the tracking area update procedure or handover procedure. This may be realized by the user equipment 130 if e.g. the last revision number of the neighbour cell information related to the subgroup, is broadcasted in each cell within the subgroup. This enables the user equipment 130 to determine whether an update is needed or not.

In some embodiments using the revision handling, the user equipment 130 includes the last revision number of the neighbour cell information in Tracking area update or handover complete or a separate message that the user equipment 130 has obtained when entering the new subgroup. The network then determines whether an update is needed or not.

In some embodiments the user equipment 130 keeps the downloaded neighbour cell information received from the base station 100 also when the user equipment 130 has left the cell 100 and/or the subgroup wherein the neighbour cell information was received. Keeping this information has the obvious advantage that the user equipment does not require to download the list again if it returns to the cell and/or the subgroup. The user equipment 130 comprises an appropriate memory to keep the neighbour cell information associated with the specific cell and/or subgroup.

The neighbour cell information associated to a cell and/or subgroup may change over time, e.g. if the operator builds out its network by adding more cells, if cells are removed from the network, or if statistics characterizing the mobility of user equipments between the cells reveal that a presumed neighbour relation between two specific cells does not, in fact, exist (i.e., no user equipments move directly between the cells). The problem arising is that if the user equipment 130 stores the neighbour cell information locally in its memory, it will be outdated when a modification is made in the neighbour cell list. This problem may be solved by revision handling.

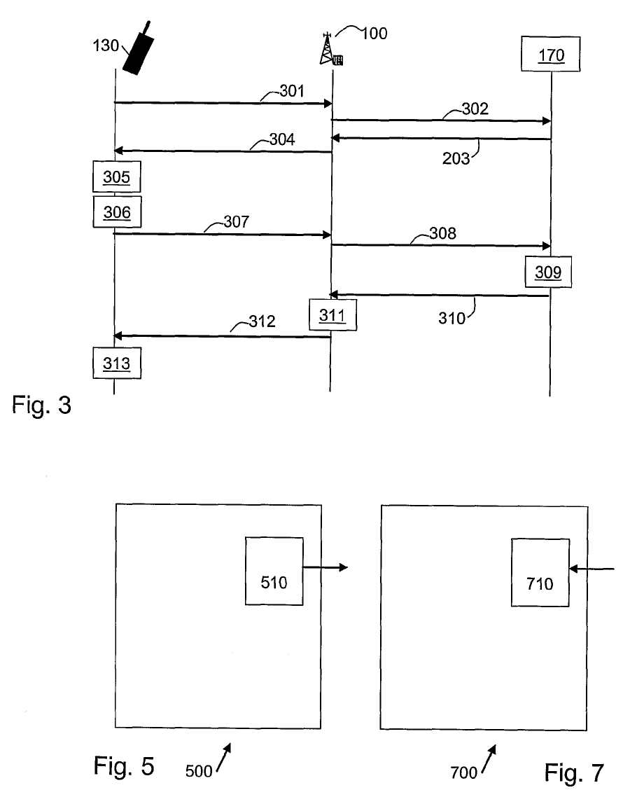

In some embodiments each neighbour cell information associated to a subgroup is related to a revision number. This may be maintained and set by the radio access network. FIG. 3 is a combined flow chart and signalling scheme depicting some embodiments of handling the neighbour cell information associated to a subgroup. The method comprises the steps of:

301. When the user equipment 130 registers to or moves to a subgroup of the radio access network 120 it sends a message to the base station 100. The base station 100 serves the cell 110, which cell 110 is comprised in the subgroup. This message may comprise information that the user equipment 130 registers to or moves to the subgroup which may be an implicit request for neighbour cell information associated to the subgroup. In some embodiments the message comprises the additional information of a request for neighbour cell information associated to the subgroup. This additional information may be indicated by a special encoding in a signalling message.

In an LTE related embodiment, the additional information may be integrated in the existing attach, tracking area update or handover procedures. In case of the information indicating that the user equipment 130 registers to the subgroup, the additional information may be integrated in an RRC connection request message in the Attach procedure. In case of the information indicating that the user equipment 130 moves to the subgroup as a result of a cell reselection, the additional information may be integrated in an RRC connection request message in the tracking area update procedure. In case of the information indicating that the user equipment 130 moves to the subgroup as a result of a handover, the additional information may be integrated in an Handover Confirm message in the handover procedure.

302. The base station 100 receives the message and understands that the user equipment 130 requires the neighbour cell information associated to the subgroup when receiving the message.

The following in this step is used for implementing the present method only in the embodiments wherein the control node 170 and not the base station 100, is the node that keeps the information of the neighbour cell information associated to the subgroup. This will trigger the base station 100 to send a request for the neighbour cell information associated to the subgroup, to the control node 170.

In some LTE related embodiments and in case of the information indicating that the user equipment 130 registers to the subgroup, the Attach procedure is used and the request may be implemented in the initial user equipment (UE) message in the Attach procedure. In some LTE related embodiments and in case of the information indicating that the user equipment 130 moves to the subgroup as a result of a cell reselection, the tracking area update procedure may be used and the request is implemented in the initial UE message in the tracking area update procedure. In some LTE related embodiments and in case of the information indicating that the user equipment 130 moves to the subgroup as a result of a handover, the handover procedure may be used and the request may be implemented in the Handover Complete message in the handover procedure.

303. This step is also used for implementing the present method only in the embodiments wherein the control node 170 and not the base station 100, is the node that has information of the latest version of neighbour cell information associated to the subgroup. The control node 170 receives the request for the neighbour cell information associated to the subgroup. This triggers the control node 170 to send the latest version of neighbour cell information associated to the subgroup, to the base station 100.

In some LTE related embodiments wherein the Attach procedure is used, the latest version of neighbour cell information associated to the subgroup, may be sent to the base station 100 integrated in an attach accept message to the base station 100. In some LTE related embodiments wherein the tracking area update procedure is used the latest version of neighbour cell information associated to the subgroup, may be sent to the base station 100 integrated in an connection release message to the base station 100. In some LTE related embodiments wherein the handover procedure is used the latest version of neighbour cell information associated to the subgroup, may be sent to the base station 100 integrated in an Handover Complete Ack message to the base station 100.

304. The base station 100 has understood that the user equipment 130 requires the neighbour cell information associated to the subgroup when receiving the message sent in step 301. The base station 100 has in some embodiments obtained the latest version of neighbour cell information associated to the subgroup from the control node 170 and in some embodiments the base station 100 is the node that has information of the latest version of neighbour cell information associated to the subgroup.

The base station sends, over a point-to point connection, to the user equipment 130, the latest version of neighbour cell information associated to the subgroup and additionally in some embodiments also a revision number related to this latest version of neighbour cell information. This is performed by means of dedicated signalling, i.e. this is a point to point transmission.

In some LTE related embodiments wherein the Attach procedure is used, the latest version of neighbour cell information associated to the subgroup and possible revision number, may be sent to the base station 100 integrated in an RRC connection Setup default Radio Bearer Setup message to the user equipment 130. In some LTE related embodiments wherein the tracking area update procedure is used the latest version of neighbour cell information associated to the subgroup and possible revision number, may be sent to the base station 100 integrated in a RRC connection release message to the user equipment 130. In some LTE related embodiments wherein the handover procedure is used the latest version of neighbour cell information associated to the subgroup and possible revision number, may be sent to the base station 100 integrated in a handover confirm message sent from user equipment 130 to the base station 100 in the target cell or a separate dedicated message to the user equipment 130

305. The user equipment 130 receives, i.e. downloads the neighbour cell information associated to the subgroup and possible revision number over a point-to-point connection. In some embodiments the neighbour cell information associated to the subgroup and its related revision number is kept in the memory of the user equipment 130. Older revisions of neighbour cell information associated to the subgroup may at this point be deleted from the memory of the user equipment 130. This means that the user equipment 130 requires obtaining new neighbour cell information associated to the subgroup only if an updated neighbour cell information associated to the subgroup is issued.

The following method steps 306-313 concern the updating procedure of the neighbour cell information associated to the subgroup and is related to some embodiments wherein the neighbour cell information associated to the subgroup and its related revision number is kept in the memory of the user equipment.

306. The user equipment 130 is turned off or moves from the subgroup. Sometimes later in a short time or a long time, the user equipment 130 then again registers to or again moves to the subgroup of the radio access network 120. The user equipment 130 obtains the identity of the subgroup from the base station 100. The identity is comprised in broadcasted system information from the base station 100. In case some LTE embodiments and handover, the identity may be obtained from a Handover Command message from a serving base station serving the cell from where the user equipment 130 came. In case of handover in some other LTE related embodiments, the user equipment may send a message, e.g. a Handover Confirm message to the target base station 100, which message comprises the identity of the source subgroup from where the user equipment 130 came. In that case the base station 100 discovers that the source identity differs from the target subgroup. The base station 100 then indicates the identity of of the subgroup i.e. the target subgroup.

The user equipment 130 may check whether it has any neighbour cell information associated to the subgroup. In this scenario the user equipment 130 finds the kept neighbour cell information associated to the subgroup and its related revision number.

307. The user equipment 130 sends a message to the base station 100. This message comprises the by the user equipment 130 kept revision number related to the neighbour cell information associated to the subgroup. The revision number comprised shall be the latest that the user equipment 130 has received from the base station 100 regarding the associated subgroup to which the user equipment 130 is currently moving or registering.

In some LTE related embodiments and in case of the information indicating that the user equipment 130 registers to the subgroup, the Attach procedure is used and the kept revision number may be integrated in the RRC connection request message in the Attach procedure. In some LTE related embodiments and in case of the information indicating that the user equipment 130 moves to the subgroup as a result of a of a cell reselection, the tracking area update procedure is used and the kept revision number may be integrated in the RRC connection request message in the Attach procedure. In some LTE related embodiments and in case of the information indicating that the user equipment 130 moves to the subgroup as a result of a handover, the additional information may be integrated in an Handover Confirm message in the handover procedure.

308. The base station 100 receives the message comprising the by the user equipment 130 kept revision number related to the neighbour cell information associated to the subgroup.

The following in this step is used for implementing the present method only in the embodiments wherein the control node 170 and not the base station 100, is the node that keeps the information of the neighbour cell information associated to the subgroup. The base station 100 forwards the by the user equipment 130 kept revision number related to the neighbour cell information associated to the subgroup, to the control node 170.

In some LTE related embodiments and in case of the information indicating that the user equipment 130 registers to the subgroup, the Attach procedure is used and the passed on kept revision number is comprised in the initial UE message to the control node 170 in the Attach procedure. In some LTE related embodiments and in case of the information indicating that the user equipment 130 moves to the subgroup as a result of a cell reselection the tracking area update procedure is used and the passed on kept revision number is comprised the initial UE message to the control node 170 in the Attach procedure. In some LTE related embodiments and in case of the information indicating that the user equipment 130 moves to the subgroup as a result of a handover, the handover procedure may be used and the request may be implemented in the Handover Complete message to the control node 170 in the handover procedure.

309. This step is also used for implementing the present method only in the embodiments wherein the control node 170 and not the base station 100, is the node that has information of the latest version of neighbour cell information associated to the subgroup. The control node 170 receives the by the user equipment 130 kept revision number related to the neighbour cell information associated to the subgroup, to the control node. This triggers the control node 170 to check whether the kept revision number is the latest revision number
310. This step is also used for implementing the present method only in the embodiments wherein the control node 170 and not the base station 100, is the node that has information of the latest version of neighbour cell information associated to the subgroup. If the control node 170 to finds that the kept revision number is not the latest revision number, the control node 170 sends the latest version of neighbour cell information associated to the subgroup and its revision number, to the base station 100 intended for updating the user equipment 130. The control node 170 may either send the complete latest list, or if the protocol supports it, simply send down the differing information preferably indicating what has changed from the version currently present in the user equipment 130.

In some LTE related embodiments wherein the Attach procedure is used, the latest version of neighbour cell information associated to the subgroup and its revision number, may be sent to the base station 100 integrated in an attach accept message to the base station 100. In some LTE related embodiments wherein the tracking area update procedure is used the latest version of neighbour cell information associated to the subgroup and its revision number, may be sent to the base station 100 integrated in an connection release message to the base station 100. In some LTE related embodiments wherein the handover procedure is used, the latest version of neighbour cell information associated to the subgroup and its revision number, may be sent to the base station 100 integrated in an Handover Complete Ack message to the base station 100.

If the control node 170 to finds that the kept revision number is the latest revision number, the control node 170 no latest version of neighbour cell information associated to the subgroup, is sent to the base station 100 intended for updating the user equipment 130.

311. The base station 100 has received from the user equipment 130, the message comprising the first revision number. The base station 100 has in some embodiments obtained the latest version of neighbour cell information associated to the subgroup and its revision number.

In some embodiments the base station 100 is the node that has information of the latest version of neighbour cell information associated to the subgroup and its revision number. In these embodiments the base station 100 checks whether the first revision number refers to the latest revision or not. If the first revision number is refers to the latest revision, no updated neighbour cell information associated to the subgroup is sent to the user equipment 130.

312. If the first revision number is not refers to the latest revision, i.e. a newer version exists, or if the base station 100 has obtained the latest version of neighbour cell information associated to the subgroup from the control node, the base station 100 sends the updated information i.e. the latest version of the neighbour cell information associated to the subgroup and its related second revision number to the user equipment 130 over a point-to-point connection. The base station 100 may either send the complete latest list, or if the protocol supports it, simply send down the differing information preferably indicating what has changed from the version currently present in the user equipment 130.

This step is also performed by means of dedicated signalling, i.e. this is a point to point transmission as all the sending steps related to FIG. 2.

In some LTE related embodiments wherein the Attach procedure is used, the updated information may be sent to the base station 100 integrated in an RRC connection Setup default Radio Bearer Setup message to the user equipment 130.

In some LTE related embodiments wherein the tracking area update procedure is used, the updated information may be sent to the base station 100 integrated in a RRC connection release message to the user equipment 130. In some LTE related embodiments wherein the handover procedure is used, the updated information may be sent to the base station 100 integrated in a message to the user equipment 130.

313. The user equipment 130 updates the neighbour cell information associated to the subgroup when the updated information is received from the base station 100. In some embodiments the updated neighbour cell information associated to the subgroup and its related second revision number is kept in the memory of the user equipment 130.
The procedure according to method steps 306-313 may then be repeated when the user equipment enters the subgroup again.

When the user equipment 130 does not move from a specific subgroup for a long period of time, a periodic subgroup update may be used to keep the neighbour cell information associated to the subgroup up to date for the user equipment 130 when it is in idle mode. In case the neighbour cell information associated to the subgroup has been modified to the extent that the user equipment 130 cannot find a neighbour cell, the user equipment 130 may carry out a new cell search procedure and find a new subgroup such as a new tracking area with updated neighbour cell information. The user equipment 130 being in active mode may be updated directly by defining a network initiated procedure to update the neighbour cell information.

In some preferred embodiments the network broadcasts the revision number of the “latest” neighbour cell information. If the user equipment 130 listens to the broadcast and finds that the revision number has changed since it received its neighbour cell information the user equipment 130 may request an update of the lists from the network that will be sent from the base station to the user equipment using dedicated signalling. This may be performed by a specific procedure or by invoking the tracking area update procedure, thereby receiving new neighbour cell information in the same way as above.

In some preferred embodiments the user equipment 130 obtains the neighbour cell information in an order that is adapted to the position of the user equipment 130, so that the user equipment 130 does not need to obtain or process the complete neighbour cell information before it can commence with measurements in the new geographical area. For example, it may be beneficial if the list is orders such that the cell which the user equipment 130 has just entered is downloaded to the user equipment 130 first of all cells, so that it is made aware of its current neighbours first.

In some embodiments the base station 110 is configured with the neighbour cell information by operation and maintenance system used to configure the RAN. This cell information may cover one or multiple subgroups such as e.g. tracking areas. Providing the cell information via the operation and maintenance system may be advantageous if the cell information does not change often over time, and if the neighbour cell information is not personalized, i.e. different users need different neighbour cell information. The reason for the latter requirement may be also be that the user equipment 130 shall not be able to be identified by a third party 100 due to security reasons, therefore the neighbour cell information may not be allowed to be personalized in this case.

In some embodiments the way of providing the neighbour cell information to the base station 100 is to provide the complete neighbour cell information from the control node 170 as described in step 303. This cell information may cover one or multiple subgroups such as e.g. one or multiple tracking areas. One advantage of this is that, since the user equipment 130 is known and identifiable in the control node 170, the neighbour cell information can be personalized. Typical cases where it is good to have personalized neighbour cell information are when certain users should be restricted to access certain cells. I.e. in some networks there may exist cells which all user equipments/subscribers are not allowed to use. In that case, it may be beneficial to have personalized neighbour cell lists. One such case is the home radio base station case where the base stations are user-deployed in the home (but still connected to the operator's network). Here, a user who has deployed a home base station in its home may not want all users to be able access this base station, but only a restricted group of people. One way to realized such restrictions would be through personalized neighbour cell information.

The method steps performed in the base station 100 will now be described in relation FIG. 4. The method comprises the following steps:

401. In some embodiments the base station 100 receives a request for neighbour cell information from the user equipment 130. In some embodiments the request for neighbour cell information is represented by a revision number of the version of the neighbour cell information that the user equipment 130 has downloaded earlier.
402. In some embodiments the base station 100 checks whether the revision number is out of date and a later version of neighbour cell information exists and if the revision number is the latest version, not performing the next steps.
403. In some embodiments the base station 100 forwards the message from the user equipment 130 received in step 401 to the control node 170
404. And in the embodiments mentioned in step 403, the base station 100 receives neighbour cell information from the control node 170.
405. The base station 100 sends a message to the user equipment 130, using a point-to-point connection over the radio link. The message comprises neighbour cell information to assist the user equipment 130 in handling mobility in idle mode. In some embodiments the radio access network 120 is divided into subgroups, each subgroup comprising a number of cells. In these embodiments the neighbour cell information comprises information associated to a subgroup such as e.g. a tracking area. In some embodiments the neighbour cell information represents accessible cells, a list of one or more neighbour cells and/or user equipment capabilities. In some embodiments the neighbour cell information represents services being supported in neighbour cells, current load in the neighbour cells, and/or what type of cells the neighbour cells are.

In some embodiments the sending and receiving method steps are performed using LTE related attach procedure when the user equipment 130 registered into a new subgroup.

In some embodiments the sending and receiving method steps are performed using LTE related tracking area update procedure when the user equipment 130 has moved into a new subgroup as a result of cell reselection.

In some embodiments the sending and receiving method steps are performed using LTE related handover procedure when the user equipment 130 moved into a new subgroup as a result of a handover.

To perform the method steps for transmitting cell information, the base station 100 comprises an arrangement 500 depicted in FIG. 5.

The base station arrangement 500 comprises a sending unit 510 adapted to send a message to the user equipment 130, using a point-to-point connection over the radio link. The message comprises neighbour cell information to assist the user equipment 130 in handling mobility in idle mode.

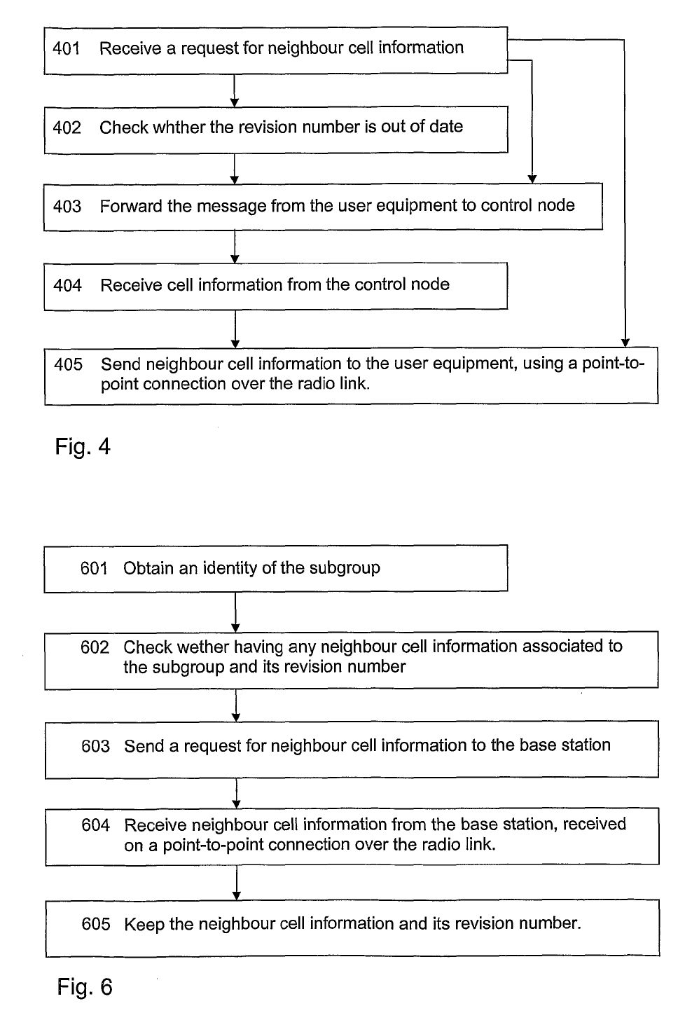

The method steps performed in the user equipment 100 will now be described in relation FIG. 6. The method comprises the steps of:

601. In some embodiments the radio access network 120 is divided into subgroups, each subgroup comprising a number of cells. In these embodiments the neighbour cell information comprises information associated to a subgroup. In some embodiments wherein the user equipment 130 moves to a subgroup it obtains an identity of the subgroup.
602. In some embodiments the user equipment 130 checks whether it has any neighbour cell information associated to the subgroup and its revision number.
603. In some embodiments the user equipment 130 sends a request for neighbour cell information to the base station 100. In some embodiments the neighbour cell information is associated with a revision number. In these embodiments the request for neighbour cell information may be represented by a revision number of a version of the neighbour cell information that the user equipment 130 has downloaded earlier.
604. The user equipment 130 receives a message from the base station 100. The message is received on a point-to-point connection over the radio link. The message comprises neighbour cell information to assist the user equipment 130 in handling mobility in idle mode. In some embodiments the radio access network 120 is divided into subgroups, each subgroup comprising a number of cells. In these embodiments the neighbour cell information comprises information associated to a subgroup such as e.g. a tracking area. In some embodiments the neighbour cell information represents accessible cells, a list of one or more neighbour cells and/or user equipment capabilities. In some embodiments the neighbour cell information represents services being supported in neighbour cells, current load in the neighbour cells, and/or what type of cells the neighbour cells are..
605. In some embodiments the user equipment 130 keeps the received neighbour cell information and its revision number.

In some embodiments the sending and receiving method steps are performed using LTE related attach procedure when the user equipment 130 registered into a new subgroup.

In some embodiments the sending and receiving method steps are performed using LTE related tracking area update procedure when the user equipment 130 has moved into a new subgroup as a result of cell reselection.

In some embodiments the sending and receiving method steps are performed using LTE related handover procedure when the user equipment 130 moved into a new subgroup as a result of a handover

To perform the method steps for transmitting cell information, the user equipment 130 comprises an arrangement 700 depicted in FIG. 7.

The user equipment arrangement 700 comprises a receiving unit 710 adapted to receive a message from the base station 100, which message is received on a point-to-point connection over the radio link. The message comprises neighbour cell information to assist the user equipment 130 in handling mobility in idle mode.

When using the word “comprise” or “comprising” it shall be interpreted as non-limiting, i.e. meaning “consist at least of”.

The present invention is not limited to the above-describe preferred embodiments. Various alternatives, modifications and equivalents may be used. Therefore, the above embodiments should not be taken as limiting the scope of the invention, which is defined by the appending claims.

1.-26. (canceled)

27. A method in a base station of transmitting cell information, the base station being adapted for communication over a radio link with a user equipment in an idle mode located in a cell in a radio access network and for serving the cell surrounded by neighbor cells, the method comprising:
sending a message to the user equipment using a point-to-point connection over the radio link, the message comprising neighbor cell information to assist the user equipment in handling mobility in idle mode.

28. The method of claim 27, wherein the radio access network is divided into subgroups, each subgroup comprising a number of cells, and the neighbor cell information comprises information associated to a subgroup.

29. The method of claim 28, wherein the information associated to a subgroup includes a tracking area.

30. The method of claim 27, wherein the neighbor cell information represents at least one of accessible cells, a list of at least one neighbor cell, and user equipment capabilities.

31. The method of claim 27, wherein the neighbor cell information represents at least one of services supported in neighbor cells, current loads in the neighbor cells, and neighbor-cell types.

32. The method of claim 27, further comprising, before sending the message, receiving a request for neighbor cell information from the user equipment.

33. The method of claim 32, wherein the request for neighbor cell information represents a revision number of a version of neighbor cell information that was sent to the user equipment in a previous message.

34. The method of claim 33, further comprising, before sending the message, checking whether the revision number is out of date and a later version of neighbor cell information exists; and if the revision number is the latest version, not sending the message to the user equipment.

35. The method of claim 32, wherein the radio access network comprises a control node and is divided into subgroups, each subgroup comprising a number of cells; the neighbor cell information comprises information associated to a subgroup; and the method further comprises, before sending the message, forwarding the request to the control node, and receiving neighbor cell information from the control node.

36. The method of claim 35, wherein receiving neighbor cell information from the control node and sending the message are performed using an attach procedure related to a Long Term Evolution radio access network when the user equipment registers in a new subgroup.

37. The method of claim 35, wherein receiving neighbor cell information from the control node and sending the message are performed using a tracking area update procedure related to a Long Term Evolution radio access network when the user equipment moves into a new subgroup as a result of cell reselection.

38. The method of claim 35, wherein receiving neighbor cell information from the control node and sending the message are performed using a handover procedure related to a Long Term Evolution radio access network when the user equipment moves into a new subgroup as a result of a handover.

39. A method in a user equipment of obtaining cell information in an idle mode, the user equipment being adapted for communication with the base station over a radio link in a cell in a radio access network served by the base station and surrounded by neighbor cells, the method comprising:
receiving a message from the base station on a point-to-point connection over the radio link, the message comprising neighbor cell information to assist the user equipment in handling mobility in idle mode.

40. The method of claim 39, wherein the radio access network is divided into subgroups, each subgroup comprising a number of cells, and the neighbor cell information comprises information associated to a subgroup.

41. The method of claim 40, wherein the information associated to a subgroup includes a tracking area.

42. The method of claim 39, wherein the neighbor cell information represents at least one of accessible cells, a list of at least one neighbor cell, and user equipment capabilities.

43. The method of claim 39, wherein the neighbor cell information represents at least one of services supported in neighbor cells, current loads in neighbor cells, and neighbor-cell types.

44. The method of claim 39, wherein the neighbor cell information is associated with a revision number.

45. The method of claim 39, wherein the radio access network is divided into subgroups, each subgroup comprising a number of cells; the neighbor cell information comprises information associated to a subgroup; and the method further comprises, before receiving the message, sending a request for neighbor cell information to the base station.

46. The method of claim 45, wherein the request represents a revision number of a version of neighbor cell information that the user equipment received in a previous message.

47. The method of claim 46, further comprising keeping received neighbor cell information and its revision number.

48. The method of claim 45, further comprising, when the user equipment moves to a subgroup and before sending the request, obtaining an identity of the subgroup, and checking whether the user equipment has neighbor cell information associated to the subgroup and its revision number.

49. The method of claim 45, wherein sending the request and receiving the message are performed using an attach procedure related to a Long Term Evolution radio access network when the user equipment registers in a new subgroup.

50. The method of claim 45, wherein sending the request and receiving the message are performed using a tracking area update procedure related to a Long Term Evolution radio access network when the user equipment moves into a new subgroup as a result of cell reselection.

51. The method of claim 45, wherein sending the request and receiving the message are performed using a handover procedure related to a Long Term Evolution radio access network when the user equipment moves into a new subgroup as a result of a handover.

52. An arrangement in a base station adapted for communication over a radio link with a user equipment in an idle mode located in a cell in a radio access network served by the base station and surrounded by neighbor cells, the arrangement comprising:
a sending unit adapted to send a message to the user equipment on a point-to-point connection over the radio link, the message comprising neighbor cell information to assist the user equipment in handling mobility in the idle mode.

53. An arrangement in a user equipment in an idle mode adapted for communication over a radio link with a base station serving a cell surrounded by neighbor cells in a radio access network, the arrangement comprising:
a receiving unit adapted to receive a message from the base station on a point-to-point connection over the radio link, the message comprising neighbor cell information to assist the user equipment in handling mobility in the idle mode.
